(19) United States
(12) Patent Application Publication
(10) Pub. No.: US 2009/0223536 A1
(43) Pub. Date: Sep. 10, 2009

(54) CLEANING APPARATUS, CLEANING TANK, CLEANING METHOD, AND METHOD FOR MANUFACTURING ARTICLE

(75) Inventors: Michinao NOMURA, Kawasaki (JP); Yoshiaki YANAGIDA, Kawasaki (JP); Shusuke KOBAYASHI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU AUTOMATION LIMITED, Kawasaki-shi (JP)

(21) Appl. No.: 12/275,803

(22) Filed: Nov. 21, 2008

(30) Foreign Application Priority Data
Mar. 10, 2008 (JP) 2008-59071

(51) Int. Cl. B08B 3/12

(52) U.S. Cl. 134/1; 134/184; 134/95.2

(57) ABSTRACT

Ultrasonic generating unit of a cleaning tank in a cleaning apparatus applies ultrasonic waves to cleaning fluid supplied into the cleaning tank from a supply port and fluid jetting unit having openings at locations corresponding to areas to be cleaned of an article to be cleaned jets the ultrasonic-applied cleaning fluid from the openings to the areas to be cleaned of the article to be cleaned.

### CROSS-REFERENCE TO RELATED APPLICATIONS

This application claims the conventional priority based on Japanese Application No. 2008-059071, filed on Mar. 10, 2008, the disclosures of which are incorporated herein by reference.

### BACKGROUND OF THE INVENTION

1. Field of the Invention

The present invention relates to a cleaning apparatus, a cleaning tank, a cleaning method and a method for manufacturing an article only cleaning an area to be cleaned of an article to be cleaned. The present invention relates to a cleaning technique in a manufacturing process of a small device, for example, a magnetic head of a HDD (Hard Disk Drive), a MEMS (Micro Electro Mechanical Systems) and an optical component (a mirror, a lens and so on).

2. Description of the Related Art

Recently, it is necessary to remove submicron foreign matters generated in manufacturing processes by precisely cleaning according to achieving higher accuracy and downsizing in small devices such as magnetic heads of HDDs, MEMS, and optical components.

As a conventional cleaning apparatus for a small device, Japanese Patent Laid-Open No. 06-55151 proposes an ultrasonic cleaning apparatus that stores a cleaning solution in a cleaning tank including an ultrasonic generator and cleans an article to be cleaned in the cleaning tank. FIG. 12 is a diagram schematically showing a conventional cleaning technique proposed by Japanese Patent Laid-Open No. 06-55151. The cleaning apparatus shown in FIG. 12 applies ultrasonic waves to cleaning fluid by an ultrasonic generating unit 21 with an article to be cleaned 1 being soaked in a cleaning tank 10 filled with the cleaning fluid. Then, foreign matters on a surface of the article to be cleaned are separated by a cavitation phenomenon. The cleaning fluid is always supplied to the cleaning tank 10 and separated foreign matters 100 are discharged with an overflow of the cleaning fluid from a top surface of the cleaning tank 10 to an outside of the cleaning tank.

However, the conventional cleaning apparatus described with reference to FIG. 12 has a problem that the foreign matters 100 close to the article to be cleaned 1 or at a corner of the cleaning tank 10 stays not to be discharged so that the foreign matters 100 in the cleaning fluid adhere to the article to be cleaned 1 when the article to be cleaned 1 is taken out of the cleaning tank 10. In particular, the conventional cleaning apparatus soaks the whole article to be cleaned 1 in the cleaning fluid for cleaning only a part of the article to be cleaned 1. Therefore, the cleaning fluid is polluted with the foreign matters 100 separated from an area other than areas to be cleaned which are parts to be cleaned of the article to be cleaned 1 (areas to be cleaned 11 in FIG. 12), thereby significantly reducing cleanliness of the cleaning fluid.

Additionally, in the case of cleaning the article to be cleaned 1 by using the conventional cleaning apparatus, the cleaning fluid adheres to an area other than the areas to be cleaned 11. Thus, drying the whole article to be cleaned 1 takes longer to have poor efficiency. Further, as shown in FIG. 13, there is a problem that the foreign matters 100 adhere to the article to be cleaned 1, when the cleaned article to be cleaned 1 is taken out of the cleaning tank 10 for being transferred to a drying apparatus.

### SUMMARY OF THE INVENTION

It is an object of the present invention to provide a cleaning apparatus suppressing adhesion of a foreign matter to an article to be cleaned by cleaning only an area to be cleaned of the article to be cleaned when the article to be cleaned is cleaned and dried.

It is another object of the present invention to provide a cleaning tank in the cleaning apparatus suppressing adhesion of a foreign matter to an article to be cleaned by cleaning only an area to be cleaned of the article to be cleaned when the article to be cleaned is cleaned and dried.

It is still another object of the present invention to provide a cleaning method for suppressing adhesion of a foreign matter to an article to be cleaned by cleaning only an area to be cleaned of the article to be cleaned when the article to be cleaned is cleaned and dried.

It is further object of the present invention to provide a method for manufacturing an article for suppressing adhesion of a foreign matter to an article to be cleaned by cleaning only an area to be cleaned of the article to be cleaned in a manufacturing process of the article when the article to be cleaned is cleaned and dried.

The cleaning apparatus of the present invention is a cleaning apparatus placing an article to be cleaned in a cleaning tank and removing a foreign matter on a surface of the article to be cleaned by using cleaning fluid. The cleaning tank comprises an ultrasonic generating unit applying an ultrasonic wave to the cleaning fluid, and a fluid jetting unit having an opening at a location corresponding to an area to be cleaned which is a part to be cleaned of the article to be cleaned. The cleaning fluid having a ultrasonic wave applied by the ultrasonic generating unit jets to the area to be cleaned of the article to be cleaned through the opening of the fluid jetting unit.

Preferably, the cleaning apparatus further comprises a structure in which the cleaning fluid is supplied to a space between the ultrasonic generating unit and the fluid jetting unit as the cleaning fluid dashes against a surface different from a bottom surface of the fluid jetting unit.

Preferably, the cleaning apparatus further comprises an unit adjusting a distance between the ultrasonic generating unit and the fluid jetting unit, and an unit adjusting a distance between the fluid jetting unit and the area to be cleaned.

Preferably, the cleaning apparatus further comprises a drying unit circulating drying fluid in the cleaning tank, jetting or sucking the drying fluid through the opening of the fluid jetting unit, and drying the cleaning fluid on the area to be cleaned of the article to be cleaned.

The cleaning tank of the present invention is a cleaning tank provided to a cleaning apparatus removing a foreign matter on a surface of an article to be cleaned by using cleaning fluid. The cleaning tank comprises a placing unit placing the article to be cleaned, an ultrasonic generating unit applying an ultrasonic wave to the cleaning fluid, and a fluid jetting unit having an opening at a location corresponding to an area to be cleaned which is a part to be cleaned of the placed article to be cleaned. The cleaning fluid having a ultrasonic wave applied by the ultrasonic generating unit jets to the area to be cleaned of the article to be cleaned through the opening of the fluid jetting unit.

Preferably, the cleaning tank further comprises a structure in which the cleaning fluid is supplied to a space between the ultrasonic generating unit and the fluid jetting unit as the cleaning fluid dashes against a surface different from a bottom surface of the fluid jetting unit.

Preferably, the cleaning tank further comprises an unit adjusting a distance between the ultrasonic generating unit and the fluid jetting unit, and an unit adjusting a distance between the fluid jetting unit and the area to be cleaned.

Preferably, the cleaning tank jets or sucks drying fluid supplied from a drying unit circulating the drying fluid in the cleaning tank through the opening of the fluid jetting unit, and dries the cleaning fluid on the area to be cleaned of the article to be cleaned.

The cleaning method of the present invention is a cleaning method in a cleaning apparatus for placing an article to be cleaned in a cleaning tank and removing a foreign matter on a surface of an article to be cleaned by using cleaning fluid. The cleaning method comprises, in an ultrasonic generating unit of the cleaning tank, applying an ultrasonic wave to the cleaning fluid, and in a fluid jetting unit of the cleaning tank, jetting the ultrasonic-applied cleaning fluid to an area to be cleaned which is a part to be cleaned of the article to be cleaned through an opening provided at a location corresponding to the area to be cleaned of the article to be cleaned.

The method for manufacturing an article of the present invention is a method for manufacturing an article. The method for manufacturing an article comprises a cleaning step of placing the article in a cleaning tank and removing a foreign matter on a surface of an article to be cleaned by using cleaning fluid. The cleaning step comprises, in an ultrasonic generating unit of the cleaning tank, supplying a ultrasonic wave to the cleaning fluid by, and in a fluid jetting unit of the cleaning tank, jetting the ultrasonic-applied cleaning fluid to an area to be cleaned which is a part to be cleaned of the article to be cleaned through an opening provided at a location corresponding to the area to be cleaned of the article to be cleaned.

A cleaning apparatus, a cleaning tank, a cleaning method and a method for manufacturing an article of the present invention jet cleaning fluid having a ultrasonic wave applied by ultrasonic generating unit to an area to be cleaned of an article to be cleaned through an opening of fluid jetting unit, and cleans only the area to be cleaned. Thus, according to the cleaning apparatus, the cleaning tank, the cleaning method and the method for manufacturing an article, it is possible to suppress generation of a foreign matter from an area other than the area to be cleaned of the article to be cleaned when cleaning the article to be cleaned so that high cleaning quality can be realized. Additionally, since adhesion of the cleaning fluid to an area other than the area to be cleaned is reduced, adhesion of a foreign matter can be suppressed when drying the article to be cleaned after cleaning and a drying time can be shortened.

The cleaning apparatus and the cleaning tank have a structure in which the cleaning fluid is supplied to a space between the ultrasonic generating unit and the fluid jetting unit as the cleaning fluid dashes against a surface different from a bottom surface of the fluid jetting unit. Thus, according to the cleaning apparatus and the cleaning tank, a pressure of the cleaning fluid in the space can be equalized so that the cleaning fluid can jet from each opening of the fluid jetting unit with a certain flow rate.

The cleaning apparatus and the cleaning tank also have a unit for adjusting a distance between the ultrasonic generating unit and the fluid jetting unit. Thus, according to the cleaning apparatus and the cleaning tank, it is possible to adjust the distance between the ultrasonic generating unit and the fluid jetting unit to a suitable distance (a distance with high cleaning efficiency) determined depending on a frequency used by the ultrasonic generating unit when applying an ultrasonic wave to the article to be cleaned.

The cleaning apparatus and the cleaning tank also have a unit for adjusting a distance between the fluid jetting unit and the area to be cleaned. Thus, according to the cleaning apparatus and the cleaning tank, it is possible to adjust the distance between the fluid jetting unit (the opening thereof) and the area to be cleaned to a suitable distance determined depending on a surface tension of the cleaning fluid, a material of the article to be cleaned, a size of a foreign matter to be removed and so on.

Further, the cleaning apparatus and the cleaning tank circulate drying fluid in the cleaning tank, jet or suck the drying fluid through the opening, and dry the cleaning fluid on the area to be cleaned of the article to be cleaned. Thus, according to the cleaning apparatus and the cleaning tank, it is possible to selectively dry the area to be cleaned corresponding to the opening. As a result, the article to be cleaned can be dried for a short time.

### BRIEF DESCRIPTION OF THE DRAWINGS

FIG. 1 is a diagram showing an exemplary basic structure of a cleaning apparatus of the present embodiment.

FIG. 2 is a diagram showing a cleaning process using the cleaning apparatus.

FIG. 3 is a diagram showing a drying process using the cleaning apparatus.

FIG. 4 is a diagram showing an example of an article to be cleaned.

FIGS. 5A and 5B are diagrams showing an exemplary internal structure of the cleaning apparatus of the embodiment of the present invention.

FIGS. 6A and 6B are diagrams showing another exemplary internal structure of the cleaning apparatus of the embodiment of the present invention.

FIG. 7 is a diagram showing a detailed example of the structure when a cleaning tank of the cleaning apparatus of the embodiment is seen from the top thereof.

FIG. 8 is a diagram showing a detailed example of the structure when the cleaning tank of the cleaning apparatus of the embodiment is seen from the side thereof.

FIGS. 9, 10 and 11 are diagrams illustrating an example of a cleaning process of the embodiment.

FIG. 12 is a diagram schematically showing a conventional cleaning technique.

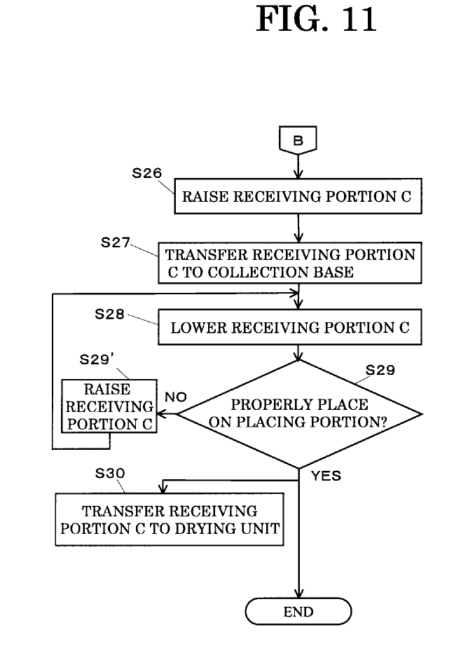

FIG. 13 is a diagram showing adhesion of foreign matters to the article to be cleaned after cleaning.

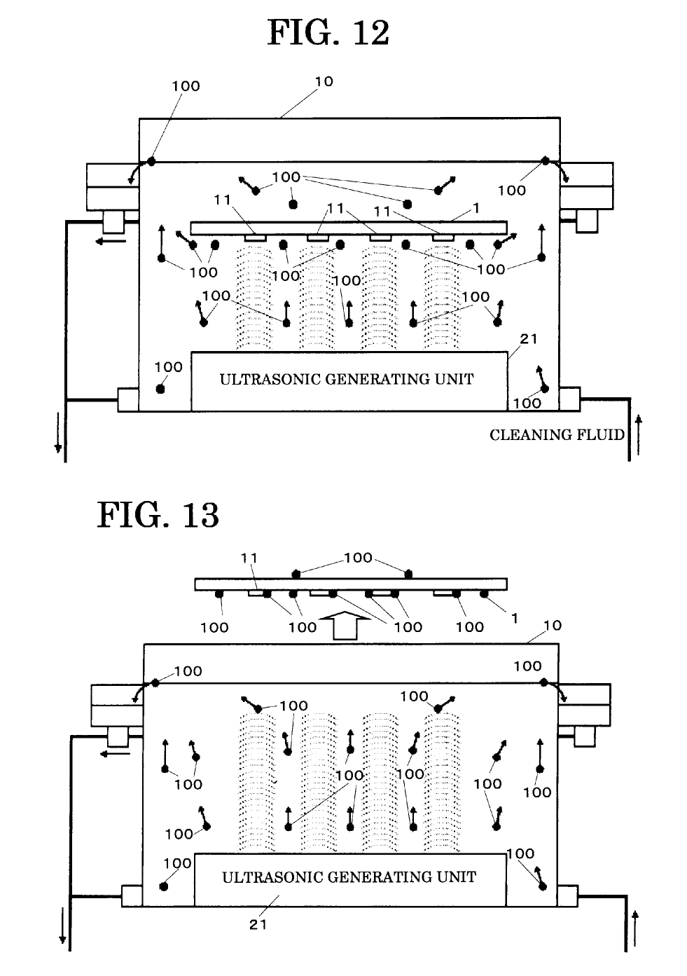

### DETAILED DESCRIPTION OF THE PREFERRED EMBODIMENTS

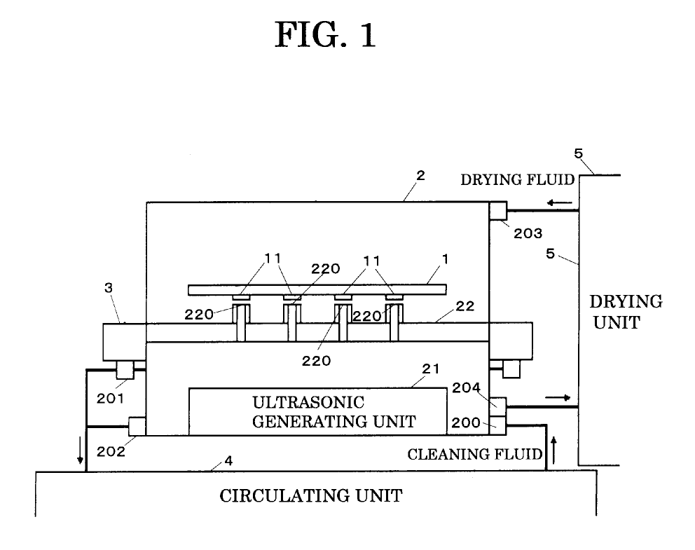

Hereinafter, an embodiment of the present invention is described with drawings. FIG. 1 is a diagram showing an exemplary basic structure of a cleaning apparatus of the present embodiment. The cleaning apparatus shown in FIG. 1 places an article to be cleaned 1 in a cleaning tank 2 and removes foreign matters on a surface of the article to be cleaned by using cleaning fluid. Among components of the cleaning apparatus shown in FIG. 1, the cleaning tank 2 has a supply port 200 for supplying the cleaning fluid and an outlet 202 for discharging the cleaning fluid, and stores the cleaning fluid. The cleaning fluid is, for example, pure water, an organic solvent and so on.

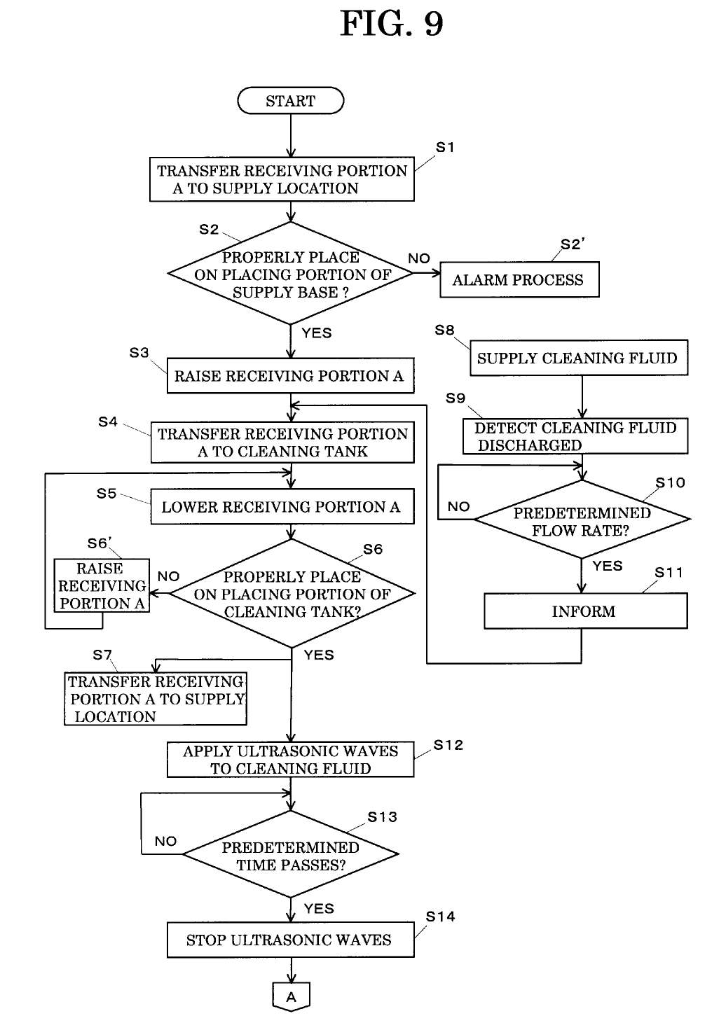

The cleaning tank 2 includes an ultrasonic generating unit 21 and a fluid jetting unit 22. The ultrasonic generating unit 21 is provided opposing the fluid jetting unit 22. The ultrasonic generating unit 21 has one ultrasonic oscillator or more. The ultrasonic generating unit 21 applies ultrasonic waves to the cleaning fluid by the ultrasonic oscillator when the cleaning fluid is supplied through the supply port 200 to a space (area) between the ultrasonic generating unit 21 and the fluid jetting unit 22 of the cleaning tank 2. The fluid jetting unit 22 is provided opposing the article to be cleaned 1 between the article to be cleaned 1 and the ultrasonic generating unit 21. The fluid jetting unit 22 includes openings 220 at locations corresponding to respective areas to be cleaned 11 (locations opposing respective areas to be cleaned 11) of the article to be cleaned 1 placed in the cleaning tank 2. The area to be cleaned 11 is a part to be cleaned of the article to be cleaned 1. In the example shown in FIG. 1, the article to be cleaned 1 has a plurality of the areas to be cleaned 11. The openings 220 have a nozzle shape projecting to a direction of the area to be cleaned. The openings 220 may be removable from the fluid jetting unit 22. Additionally, the fluid jetting unit 22 has a structure of adjusting a distance between the openings 220 and the areas to be cleaned 11 (for example, a height adjusting member 26 described below with reference to FIG. 8). The cleaning fluid having the ultrasonic waves applied by the ultrasonic generating unit 21 jets to the areas to be cleaned 11 of the article to be cleaned 1 through the openings 220 of the fluid jetting unit 22 for cleaning the areas to be cleaned 11 of the article to be cleaned 1.

Fluid collecting unit 3 has an outlet 201 for the cleaning fluid and discharges the cleaning fluid jetting from the fluid jetting unit 22 outside the tank through the outlet 201. Accordingly, the article to be cleaned 1 is not soaked in the cleaning fluid when cleaning the article to be cleaned 1. Circulating unit 4 is connected to the supply port 200 and the outlet 202 of the cleaning tank 2 and the outlet 201 of the fluid collecting unit 3. The circulating unit 4 supplies the cleaning fluid from the supply port 200 to the space between the ultrasonic generating unit 21 and the fluid jetting unit 22 in the cleaning tank 2, and discharges the cleaning fluid from the outlet 202. The circulating unit 4 supplies a predetermined flow rate of the cleaning fluid into the cleaning tank 2 so that the predetermined flow rate of the cleaning fluid jets from the openings 220 of the fluid jetting unit 22 to the direction of the areas to be cleaned 11. The circulating unit 4 may clarify the cleaning fluid, for example, by a filter provided to a circulating path of the cleaning fluid.

A drying unit 5 circulates drying fluid in the cleaning tank 2, jets or sucks the drying fluid through the openings 220 of the fluid jetting unit 22, and dries the cleaning fluid on the areas to be cleaned 11 of the article to be cleaned 1. For example, after cleaning the article to be cleaned 1, the drying unit 5 supplies the drying fluid from a supply port 203 into the cleaning tank 2 and sucks the drying fluid from an outlet 204. As a result, the drying fluid supplied into the cleaning tank 2 is sucked through the openings 220 provided at the locations corresponding to the areas to be cleaned 11 of the article to be cleaned 1 and the areas to be cleaned 11 are dried. The drying fluid is, for example, clean dry air.

The drying unit 5 may supply the drying fluid from the outlet 204 into the cleaning tank 2 and suck the drying fluid from the supply port 203. In the case where the drying unit 5 supplies the drying fluid from the outlet 204 into the cleaning tank 2, drying fluid supplied into the cleaning tank 2 jets to the areas to be cleaned 11 through the openings 220 at the locations corresponding to the areas to be cleaned 11 of the article to be cleaned 1 and the areas to be cleaned 11 are dried.

The drying unit 5 may have a filter in a supplying path of the drying fluid and clarify the drying fluid by using the filter. Also, a heater may be provided to the supplying path of the drying fluid for shortening a drying time of the article to be cleaned 1.

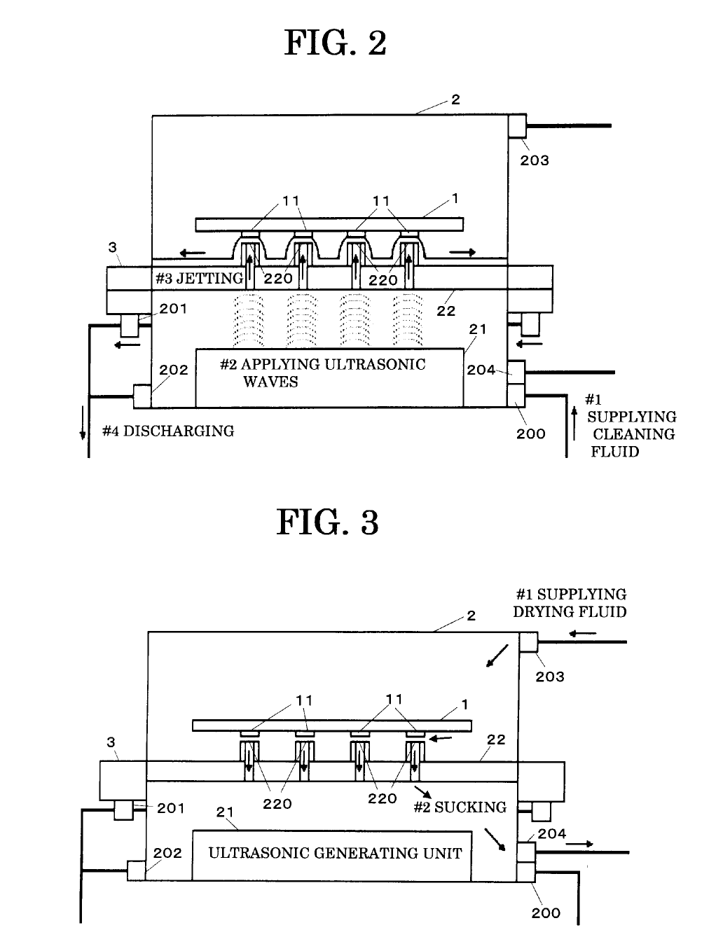

FIG. 2 is a diagram showing a cleaning process using the cleaning apparatus shown in FIG. 1. The circulating unit 4 supplies the cleaning fluid from the supply port 200 into the cleaning tank 2 (see #1 in FIG. 2). The space between the fluid jetting unit 22 and the ultrasonic generating unit 21 in the cleaning tank 2 is filled with the cleaning fluid. The ultrasonic generating unit 21 applies ultrasonic waves to the cleaning fluid (see #2 in FIG. 2). The fluid jetting unit 22 jets the ultrasonic-applied cleaning fluid through the openings 220 to the areas to be cleaned 11 of the article to be cleaned 1 for cleaning the areas to be cleaned 11. The cleaning fluid contacting the areas to be cleaned 11 is discharged from the outlet 201 of the fluid collecting unit 3. According to the cleaning apparatus of the present embodiment, the cleaning fluid having the ultrasonic waves applied can be jetted only to the areas to be cleaned 11 of the article to be cleaned 1. Additionally, cleanliness of the areas to be cleaned 11 can be maintained because the cleaning fluid contacting the areas to be cleaned 11 is immediately discharged. Also, it is possible to suppress adhesion of foreign matters to an area other than the areas to be cleaned 11 of the article to be cleaned 1 because adhesion of the cleaning fluid to an area other than the areas to be cleaned 11 is reduced. As a result, overall cleaning quality is improved.

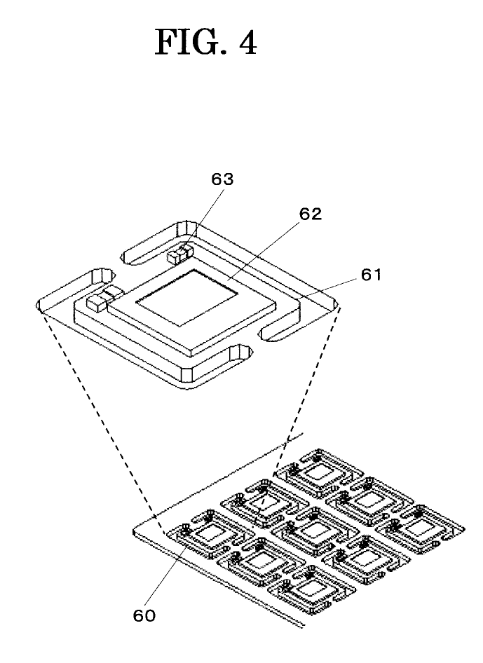

FIG. 3 is a diagram showing a drying process using the cleaning apparatus shown in FIG. 1. The drying unit 5 supplies the drying fluid from the supply port 203 into the cleaning tank 2 (see #1 in FIG. 3) and sucks the drying fluid from the outlet 204. The drying fluid supplied into the cleaning tank 2 is sucked to a side of the outlet 204 through the openings 220 (see #2 in FIG. 3) and dries the areas to be cleaned 11. According to the cleaning apparatus of the present embodiment, a flow velocity of the drying fluid close to the areas to be cleaned 11 is faster than a flow velocity of the drying fluid close to an area other than the areas to be cleaned 11 of the article to be cleaned 1 because the openings 220 project to a direction of the areas to be cleaned 11. Accordingly, drying the areas to be cleaned 11 can be accelerated. It is also possible to suppress dust generation from an area other than the areas to be cleaned 11 of the article to be cleaned 1. Further, according to the cleaning apparatus of the present embodiment, the drying process can be performed in the cleaning tank 2 so that efficiency is high.

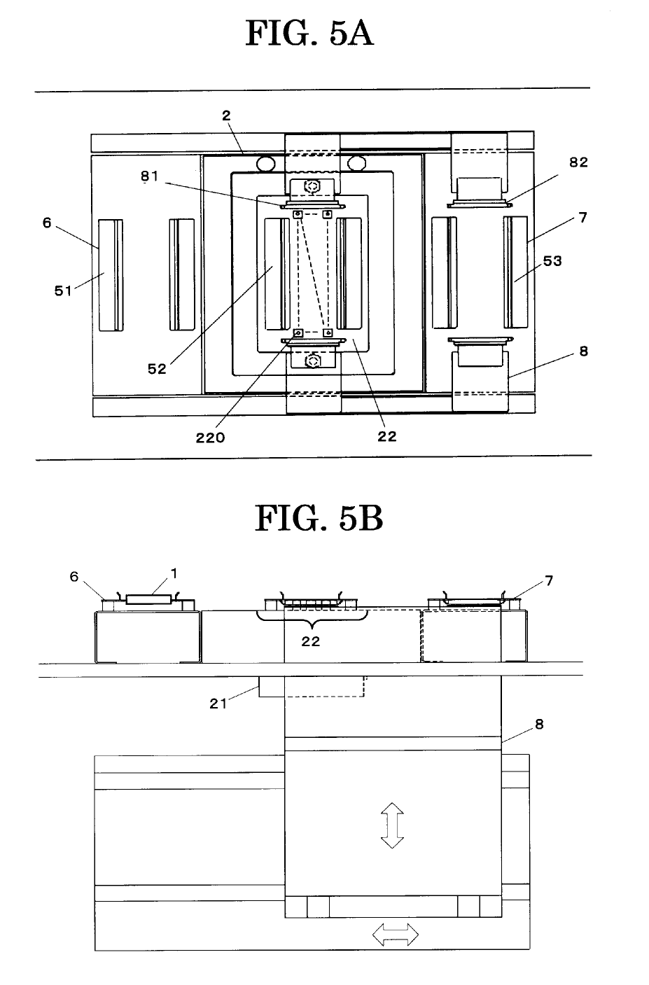

Hereinafter, an embodiment of the present invention is described. FIG. 4 is a diagram showing an example of an article to be cleaned. The article to be cleaned is a plate 60 having a plurality of image sensors 61 used for, for example, digital cameras and so on arranged. Several tens of the image sensors 61 are arranged in the plate having an outside dimension of 150 to 200 mm×50 to 70 mm. The image sensor 61 includes an image sensor 62 such as a CCD or a CMOS and a capacitor 63 and an area to be cleaned is a mounted surface on the order of 10 mm×10 mm.

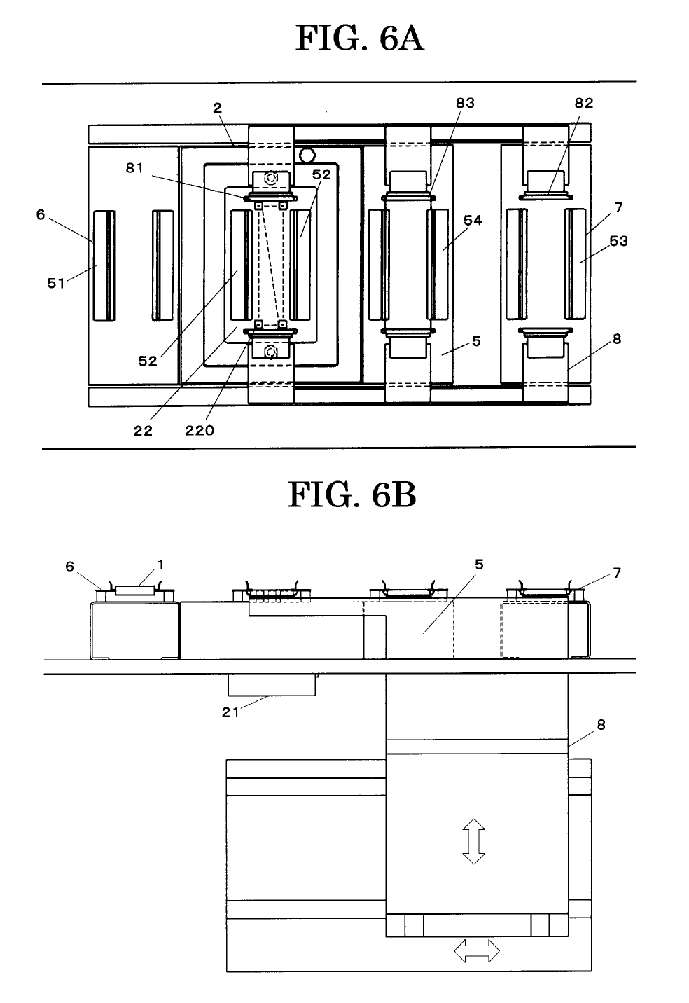

FIGS. 5A and 5B are diagrams showing an exemplary internal structure of the cleaning apparatus of the embodiment of the present invention. FIG. 5A shows the exemplary internal structure when the cleaning apparatus is seen from the top thereof. FIG. 5B shows the exemplary internal structure when the cleaning apparatus is seen from the front face thereof. The cleaning apparatus shown in FIGS. 5A and 5B includes basic components of the cleaning apparatus above described with reference to FIG. 1 (for example, fluid jetting unit, ultrasonic generating unit, circulating unit, drying unit, fluid collecting unit and so on). The openings 220 are provided according to the number of areas to be cleaned of the article to be cleaned 1. The cleaning apparatus shown in FIGS. 5A and 5B also includes a supply base 6 having the article to be cleaned 1 stood by at a supply location in the cleaning apparatus, a collection base 7 having the article to be cleaned 1 stood by at a collection location in the cleaning apparatus, and transferring unit 8 for transferring the article to be cleaned 1 from the supply base 6 to the cleaning tank 2, and then, from the cleaning tank 2 to the collection base 7. The supply base 6, the cleaning tank 2 and the collection base 7 respectively have placing portions 51, 52 and 53 in FIG. 5A. The placing portion is a portion where the article to be cleaned 1 is placed. The transferring unit 8 moves receiving portion 81 (receiving portion A) and receiving portion 82 (receiving portion C) for receiving the article to be cleaned 1 up and down, left and right, and therefore, the article to be cleaned 1 is transferred to the supply location, the cleaning tank 2 and the collection location. The receiving portions are provided one less than the number of locations where the article to be cleaned 1 stops and each of the receiving portions works with each other for an operation. Driving portion (not shown) of the transferring unit 8 is provided lower than the article to be cleaned 1 in diagram of the dust generation.

The cleaning tank 2 including the ultrasonic generating unit 21, the fluid jetting unit 22 and the fluid collecting unit (not shown) and the transferring unit 8 are included in a sealed housing. A plurality of the cleaning tanks 2 may be provided between the supply base 6 and the collection base 7.

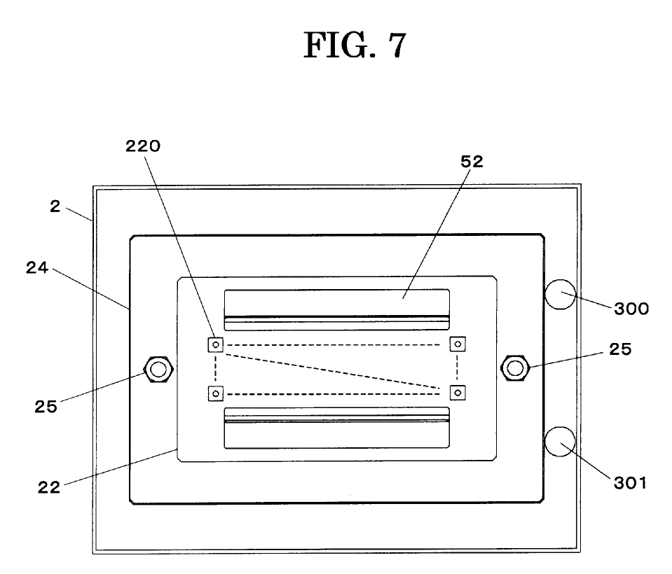

As shown in FIGS. 6A and 6B, the cleaning apparatus of the embodiment may have another structure in which the drying unit 5 is provided between the cleaning tank 2 and the collection base 7. The drying unit 5 has a structure of, for example, having an opening bigger than an outside dimension of the article to be cleaned 1 below the article to be cleaned 1 and sucking an upper atmosphere by the opening. In the exemplary structure shown in FIGS. 6A and 6B, the transferring unit 8 has three receiving portions, which are the receiving portion 81 (receiving portion A), the receiving portion 82 (receiving portion C) and a receiving portion 83 (receiving portion B). The drying unit 5 has a placing portion 54 shown in FIG. 6A. The cleaning fluid used in the embodiment is, for example, pure water and the drying fluid is, for example, clean dry air. Additionally, the respective placing portions 51, 52, 53 and 54 of the supply base 6, the cleaning tank 2, the collection base 7 and the drying unit 5 have photo sensors (not shown) detecting whether the article to be cleaned 1 is placed on the placing portion thereof and informing a detection result to the transferring unit 8.

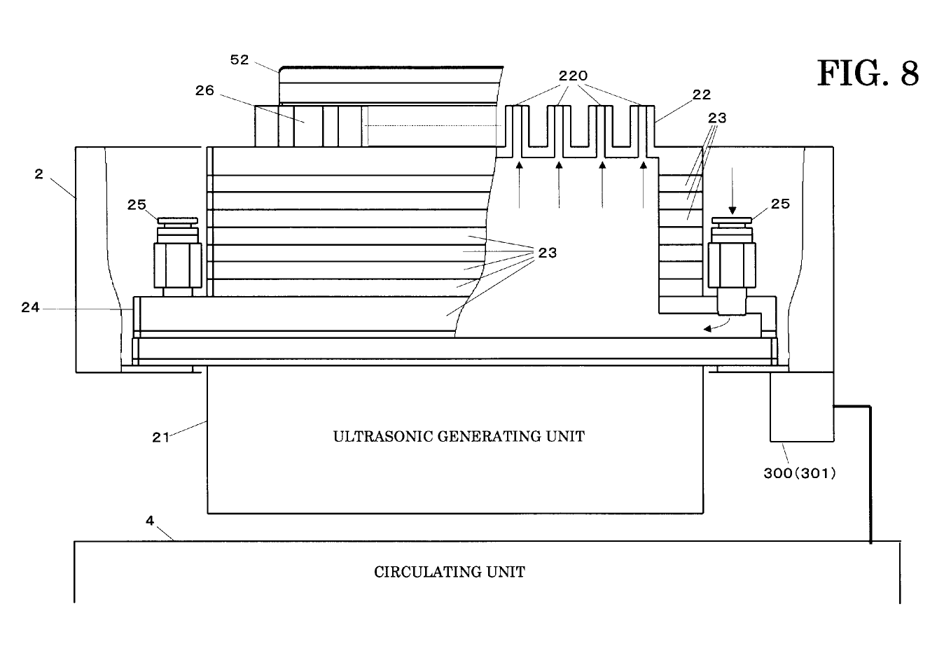

Hereinafter, a structure of the cleaning tank included in the cleaning apparatus of the embodiment is described in detail with reference to FIGS. 7 and 8. FIG. 7 is a diagram showing a detailed example of the structure when the cleaning tank of the cleaning apparatus of the embodiment is seen from the top thereof. FIG. 8 is a diagram showing a detailed example of the structure when the cleaning tank of the cleaning apparatus of the embodiment is seen from the side thereof. The cleaning tank 2 is, for example, a rectangular parallelepiped and a top surface thereof is opened for taking the article to be cleaned 1 in and out, as shown in FIG. 7. A supply port 300 and an outlet 301 for the cleaning fluid are provided on a bottom surface. The ultrasonic generating unit 21 is also provided on a bottom surface in the tank. As shown in FIG. 8, the fluid jetting unit 22 is provided over the ultrasonic generating unit 21 through a plurality of height adjusting members 23. A space between the ultrasonic generating unit 21 and the fluid jetting unit 22 is a sealed hollow structure. A distance between the ultrasonic generating unit 21 and the fluid jetting unit 22 is adjusted by the number of inserted height adjusting members 23 so as to be a suitable distance (a distance with high cleaning efficiency) determined depending on a frequency used by the ultrasonic generating unit 21 (a frequency used for applying ultrasonic waves). Joints 25 of a base portion 24 of the height adjusting member 23 and the supply port 300 on the bottom surface of the cleaning tank 2 are joined by a tube. The circulating unit 4 connected to the supply port 300 and the outlet 301 supplies the cleaning fluid from the supply port 300 into the hollow structure through the joints 25. The cleaning fluid jets from the openings 220 to a direction of the placing portion 52 after the hollow structure is filled with the cleaning fluid.

A plurality of the openings 220 of the fluid jetting unit 22 have a nozzle shape. In the embodiment, the areas to be cleaned have, for example, a rectangular shape and a top surface of the opening 220 has the identical shape. The openings 220 may be removable from the fluid jetting unit 22. A shape of an opposed surface and an arrangement of the openings 220 may be changed depending on a shape and an arrangement of the areas to be cleaned. For example, in the case of cleaning an article to be cleaned having areas to be cleaned with different heights, the heights of the openings 220 can be adjusted so as to have a certain distance between the openings 220 and the areas to be cleaned. Additionally, the cleaning fluid from the joints 25 dashes to a top surface of the ultrasonic generating unit 21 so that a pressure of the cleaning fluid in the hollow structure can be equalized and the cleaning fluid can jet from each of the openings 220 with a certain flow rate. Accordingly, the cleaning apparatus shown in FIG. 8 has a structure in which the cleaning fluid is supplied to a space between the ultrasonic generating unit 21 and the fluid jetting unit 22 as the cleaning fluid dashes against a surface different from a bottom surface of the fluid jetting unit 22 (for example, the top surface of the ultrasonic generating unit 21).

The placing portion 52 having the article to be cleaned 1 placed is provided over a top surface of the fluid jetting unit 22. A height adjusting member 26, which is provided on the top surface of the fluid jetting unit 22, can adjust a distance between the openings 220 of the fluid jetting unit 22 and the areas to be cleaned of the article to be cleaned 1 placed on the placing portion 52 depending on, for example, a surface tension of the cleaning fluid, a material of the article to be cleaned and a size of a foreign matter to be removed. The height adjusting member 26 is adjusted, for example, by using a screw and a nut.

A structure may be employed in which, for example, the distance between the areas to be cleaned and the ultrasonic generating unit 21 can be variable when cleaning and drying by using the transferring unit 8 (see FIG. 6B). Also, a structure may be employed in which the distance between the areas to be cleaned and the ultrasonic generating unit 21 can be set at different distances when cleaning and when drying respectively.

When the cleaning fluid jetting from the openings 220 runs down the top surface of the fluid jetting unit 22 to the bottom surface of the cleaning tank 2, the cleaning fluid is discharged outside of the tank through the outlet 301 on the bottom surface of the cleaning tank 2.

A sucking port may be provided on an outer periphery of the opening 220 for effectively collecting the cleaning fluid between the areas to be cleaned and the openings 220. Also, a hydrophilic surface treatment may be performed to a contact surface of the opening 220 and the cleaning fluid. Further, a porous body such as ceramic may be used for a material of the opening 220.

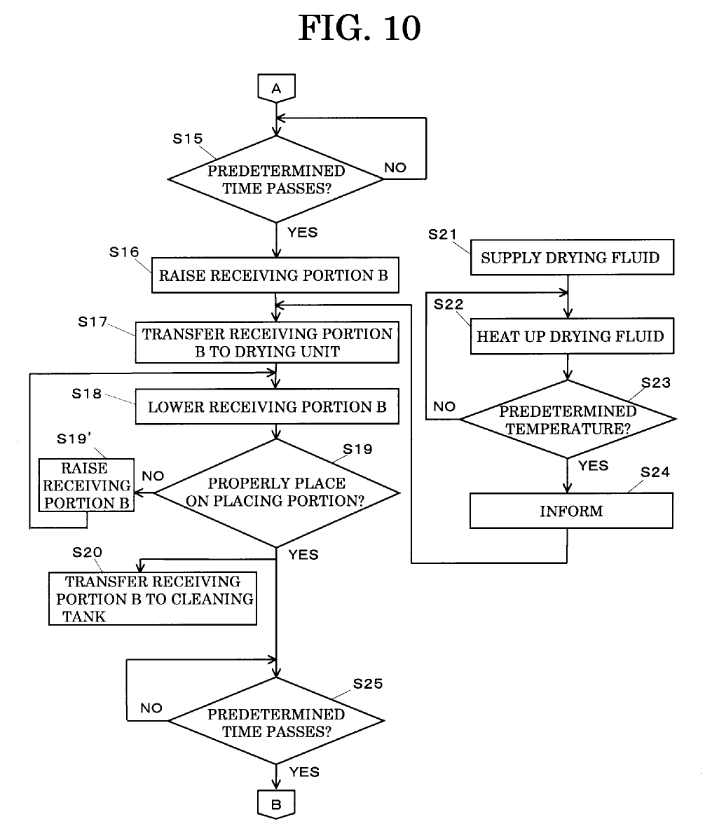

FIGS. 9, 10, and 11 are diagrams showing an example of a cleaning process of the embodiment. In FIGS. 9 to 11, a cleaning process by the cleaning apparatus having the structure shown in FIGS. 6 to 8 is described as an example. Serial cleaning operations to one article to be cleaned 1 are performed by a supplying step (steps S1 to S6′ in FIG. 9), an ultrasonic cleaning step (steps S12 to S14 in FIG. 9), a rinse cleaning step (steps S15 to S19′ in FIG. 10), and a drying step (step S25 in FIG. 10 and steps S26 to S29′ in FIG. 11) in the order named.

First, as the supplying step, the transferring unit 8 shown in FIGS. 6A and 6B transfers the receiving portion A (the receiving portion 81) to the supply location in step S1 in FIG. 9. A door of the housing is opened to place the article to be cleaned 1 on the supply base 6 with the receiving portion A being lower than the supply location. When the door is closed and a start button is pushed, the transferring unit 8 determines whether the article to be cleaned 1 is properly placed on the placing portion 51 based on a detection result of the article to be cleaned 1 by a photo sensor attached to the placing portion 51 of the supply base 6 in step S2. When the transferring unit 8 determines that the article to be cleaned 1 is not properly placed on the placing portion 51, an alarm process is performed in step S2′. If the transferring unit 8 determines that the article to be cleaned 1 is properly placed on the placing portion 51, the transferring unit 8 raises the receiving portion A in step S3. A top surface of the receiving portion A contacts an under surface of the article to be cleaned 1 for raising the article to be cleaned 1 during raising the receiving portion A. When the transferring unit 8 is informed from flow rate detecting unit described below that a flow rate of the cleaning fluid reaches a predetermined flow rate, the transferring unit 8 transfers the receiving portion A over the placing portion 52 of the cleaning tank 2 with the receiving portion A raising the article to be cleaned 1 in step S4. When the receiving portion A is transferred over the placing portion 52 of the cleaning tank 2, the transferring unit 8 lowers the receiving portion A in step S5. As a result, the article to be cleaned 1 is placed on the placing portion 52.

Next, the transferring unit 8 determines whether the article to be cleaned 1 is properly placed on the placing portion 52 based on a detection result of the article to be cleaned 1 by a photo sensor of the placing portion 52 in step S6. When the transferring unit 8 determines that the article to be cleaned 1 is not properly placed on the placing portion 52, the receiving portion A is raised in step S6′, and then, the process returns to the step S5. When the transferring unit 8 determines that the article to be cleaned 1 is properly placed on the placing portion 52, the transferring unit 8 transfers the receiving portion A to the supply location in step S7.

On the other hand, apart from the supplying step, for example, a flow rate detecting unit (not shown) close to the circulating unit 4 or the outlet 301 (see FIG. 8) performs a process of detecting whether the flow rate of the cleaning fluid to the cleaning tank 2 reaches a predetermined flow rate and informing a detection result to the transferring unit 8. That is, the circulating unit 4 supplies the cleaning fluid from the supply port 300 in step S8 in FIG. 9, and detects the cleaning fluid discharged from the outlet 301 in step S9. The flow rate detecting unit determines whether the flow rate of the cleaning fluid reaches the predetermined flow rate in step S10. When the flow rate detecting unit determines that the flow rate of the cleaning fluid does not reach the predetermined flow rate, the process returns to the step S10. When the flow rate detecting unit determines that the flow rate of the cleaning fluid reaches the predetermined flow rate, the flow rate detecting unit informs the transferring unit 8 that the flow rate of the cleaning fluid reaches the predetermined flow rate in step S11, and the process proceeds to the step S4. Reaching the predetermined flow rate of the flow rate of the cleaning fluid unit that the predetermined flow rate jets to the areas to be cleaned from the openings 220 of the fluid jetting unit 22.

Next, an ultrasonic cleaning step is described. When the article to be cleaned 1 is properly placed on the placing portion 52, the ultrasonic generating unit 21 applies ultrasonic waves to the cleaning fluid in step S12. At this time, the ultrasonic-applied cleaning fluid dashes to the areas to be cleaned 11 of the article to be cleaned 1 from below and only the areas to be cleaned 11 are cleaned. The ultrasonic generating unit 21 determines whether a predetermined ultrasonic application time passes in step S13. When the ultrasonic generating unit 21 determines that the predetermined ultrasonic application time does not pass, the process returns to the step S13. If the ultrasonic generating unit 21 determines that the predetermined ultrasonic application time passes, the ultrasonic generating unit 21 stops an ultrasonic application process in step S14, and the process proceeds to step S15 in FIG. 10.

Next, a rinse cleaning step is described. The transferring unit 8 waits for a predetermined time to pass as the predetermined flow rate from the openings 220 of the fluid jetting unit 22 jets to the areas to be cleaned 11 in the step S15 in FIG. 10. While the transferring unit 8 waits for the predetermined time to pass, foreign matters floated in the cleaning fluid by ultrasonic cleaning are removed from areas close to the areas to be cleaned 11. After the predetermined time passes, the transferring unit 8 raises the receiving portion B (the receiving portion 83) in step S16. As a result, a top surface of the receiving portion B contacts the under surface of the article to be cleaned 1, and the article to be cleaned 1 is raised. When the transferring unit 8 is informed from a temperature detecting unit described below that a temperature of the drying fluid reaches a predetermined temperature, the transferring unit 8 transfers the receiving portion B over the placing portion 54 of the drying unit 5 with the article to be cleaned 1 being raised in step S17. Then, the transferring unit 8 lowers the receiving portion B in step S18. As a result, the article to be cleaned 1 is placed on the placing portion 54. The transferring unit 8 determines whether the article to be cleaned 1 is properly placed on the placing portion 54 based on a detection result of the article to be cleaned 1 by a photo sensor attached to the placing portion 54 in step S19. When the transferring unit 8 determines that the article to be cleaned 1 is not properly placed on the placing portion 54, the receiving portion B is raised in step S19′, and then, the process returns to step S18. If the transferring unit 8 determines that the article to be cleaned 1 is properly placed on the placing portion 54, the transferring unit 8 transfers the receiving portion B to the cleaning tank 2 in step S20. The receiving portion A works with the receiving portion B to operate similarly when supplying the article to be cleaned 1. When the article to be cleaned 1 is placed on the supply base 6, the receiving portion A places the article to be cleaned 1 on the placing portion 52 of the cleaning tank 2 for ultrasonic cleaning the article to be cleaned 1.

Apart from the rinse cleaning step, for example, the temperature detecting unit (not shown) of the drying unit 5 performs a process of determining whether a temperature of the drying fluid supplied from the drying unit 5 to an area close to the placing portion 54 having the article to be cleaned 1 placed reaches the predetermined temperature, and informing a detection result to the transferring unit 8. That is, the drying unit 5 supplies the drying fluid to the area close to the placing portion 54 in step S21 in FIG. 10 in step S21, and heats up the drying fluid in step S22. The temperature detecting unit of the drying unit 5 determines whether the temperature of the drying fluid reaches the predetermined temperature in step S23. When the temperature detecting unit determines that the temperature of the drying fluid does not reach the predetermined temperature, the process returns to step S22. When the temperature detecting unit determines that the temperature of the drying fluid reaches the predetermined temperature, the temperature detecting unit informs the transferring unit 8 that the temperature of the drying fluid reaches the predetermined temperature in step S24, and the process proceeds to the step S17.

Next, a drying step is described. When the article to be cleaned 1 is properly placed on the placing portion 54, the transferring unit 8 waits for a predetermined time to pass in step S25. While the transferring unit 8 waits for the predetermined time to pass, the cleaning fluid adhered on the areas to be cleaned 11 by the rinse cleaning evaporates to be removed. After the predetermined time passes, the transferring unit 8 raises the receiving portion C (the receiving portion 82) in step S26 in FIG. 11. A top surface of the receiving portion C contacts the under surface of the article to be cleaned 1, and the article to be cleaned 1 are raised. The transferring unit 8 transfers the receiving portion C raising the article to be cleaned 1 over the collection base 7 in step S27. The transferring unit 8 lowers the receiving portion C in step S28, and the article to be cleaned 1 is placed on the placing portion 53 of the collection base 7. The transferring unit 8 determines whether the article to be cleaned 1 is properly placed on the placing portion 53 based on a detection result of the article to be cleaned 1 by a photo sensor attached to the placing portion 53 in step S29. When the transferring unit 8 determines that the article to be cleaned 1 is not properly placed on the placing portion 53, the receiving portion C is raised in step S29′, and then, the process returns to step S28. When the transferring unit 8 determines that the article to be cleaned 1 is properly placed on the placing portion 53, the transferring unit 8 transfers the receiving portion C to the drying unit 5 in step S30. The receiving portions A and B work with an operation of the receiving portion C to operate similarly when supplying the article to be cleaned 1 and when ultrasonic cleaning and rinse cleaning. For example, the article to be cleaned 1 placed on the supply base 6 is transferred to the placing portion 52 of the cleaning tank 2 by the receiving portion A to be ultrasonic cleaned and rinse cleaned. The article to be cleaned 1, which is placed on the placing portion 52 to be ultrasonic cleaned and rinse cleaned, is transferred to the placing portion 54 of the drying unit 5 by the receiving portion B for drying.

An appearance defect rate is 10 to 20% when the plate 60 shown in FIG. 4 is cleaned by the conventional cleaning method. On the other hand, the appearance defect rate is 0.2% when the plate 60 is cleaned by the cleaning apparatus of the embodiment of the present invention shown in FIGS. 6 to 8. Thus, cleaning quality is significantly improved. Additionally, the cleaning apparatus of the embodiment of the present invention cleans only the areas to be cleaned, and therefore, a time taking from cleaning to drying can be shortened to one-tenth compared with the conventional technique.

The cleaning apparatus of the embodiment can be applied to cleaning an article to be cleaned (for example, an article or a member of the article) in a manufacturing process of an article, for example, a magnetic head of a HDD, MEMS and an optical component. That is, the method for manufacturing an article of the present embodiment is a method for manufacturing an article. The method, for example, has a cleaning step of placing the article in the cleaning tank 2 shown in FIG. 1 and removing a foreign matter on a surface of the article to be cleaned (for example, the article or the member of the article) by using cleaning fluid supplied into the cleaning tank 2 by the circulating unit 4. In the cleaning step, for example, the ultrasonic generating unit 21 of the cleaning tank 2 applies ultrasonic waves to the cleaning fluid supplied into the cleaning tank 2, and the fluid jetting unit 22 of the cleaning tank 2 jets the ultrasonic-applied cleaning fluid to the areas to be cleaned 11 which are parts to be cleaned of the article to be cleaned from the openings 220 provided at locations corresponding to the areas to be cleaned 11.

As described above, according to the cleaning apparatus, the cleaning tank, the cleaning method and the method for manufacturing an article, it is possible to suppress generation of a foreign matter from an area other than the area to be cleaned of the article to be cleaned when cleaning the article to be cleaned so that high cleaning quality can be realized. Additionally, since adhesion of the cleaning fluid to an area other than the area to be cleaned is reduced, adhesion of a foreign matter can be suppressed when drying the article to be cleaned after cleaning and a drying time can be shortened.

According to the cleaning apparatus and the cleaning tank, the cleaning fluid can jet from each opening of the fluid jetting unit with a certain flow rate. Also, according to the cleaning apparatus and the cleaning tank, it is possible to adjust the distance between the ultrasonic generating unit and the fluid jetting unit to a suitable distance (a distance with high cleaning efficiency) determined depending on a frequency used by the ultrasonic generating unit when applying an ultrasonic wave to the article to be cleaned.

According to the cleaning apparatus and the cleaning tank, it is possible to adjust the distance between the fluid jetting unit (the opening thereof) and the area to be cleaned to a suitable distance determined depending on a surface tension of the cleaning fluid, a material of the article to be cleaned, a size of a foreign matter to be removed and so on. Also, according to the cleaning apparatus, the cleaning tank and the cleaning method, it is possible to selectively dry the area to be cleaned corresponding to the opening. As a result, the article to be cleaned can be dried for a short time.

What is claimed is:

1. A cleaning apparatus placing an article to be cleaned in a cleaning tank and removing a foreign matter on a surface of the article to be cleaned by using cleaning fluid,
wherein the cleaning tank comprises:
an ultrasonic generating unit applying an ultrasonic wave to the cleaning fluid, and
a fluid jetting unit having an opening at a location corresponding to an area to be cleaned which is a part to be cleaned of the article to be cleaned,
wherein the cleaning fluid having a ultrasonic wave applied by the ultrasonic generating unit jets to the area to be cleaned of the article to be cleaned through the opening of the fluid jetting unit.

2. The cleaning apparatus according to claim 1, further comprises a structure in which the cleaning fluid is supplied to a space between the ultrasonic generating unit and the fluid jetting unit as the cleaning fluid dashes against a surface different from a bottom surface of the fluid jetting unit.

3. The cleaning apparatus according to claim 1, further comprising:
an unit adjusting a distance between the ultrasonic generating unit and the fluid jetting unit; and
an unit adjusting a distance between the fluid jetting unit and the area to be cleaned.

4. The cleaning apparatus according to claim 1, further comprises a drying unit circulating drying fluid in the cleaning tank, jetting or sucking the drying fluid through the opening of the fluid jetting unit, and drying the cleaning fluid on the area to be cleaned of the article to be cleaned.

5. A cleaning tank provided to a cleaning apparatus removing a foreign matter on a surface of an article to be cleaned by using cleaning fluid, comprising:
a placing unit placing the article to be cleaned;
an ultrasonic generating unit applying an ultrasonic wave to the cleaning fluid; and
a fluid jetting unit having an opening at a location corresponding to an area to be cleaned which is a part to be cleaned of the placed article to be cleaned,
wherein the cleaning fluid having a ultrasonic wave applied by the ultrasonic generating unit jets to the area to be cleaned of the article to be cleaned through the opening of the fluid jetting unit.

6. The cleaning tank according to claim 5, further comprises a structure in which the cleaning fluid is supplied to a space between the ultrasonic generating unit and the fluid jetting unit as the cleaning fluid dashes against a surface different from a bottom surface of the fluid jetting unit.

7. The cleaning tank according to claim 5, further comprising:
an unit adjusting a distance between the ultrasonic generating unit and the fluid jetting unit; and
an unit adjusting a distance between the fluid jetting unit and the area to be cleaned.

8. The cleaning tank according to claim 5, wherein the cleaning tank jets or sucks drying fluid supplied from a drying unit circulating the drying fluid in the cleaning tank through the opening of the fluid jetting unit, and dries the cleaning fluid on the area to be cleaned of the article to be cleaned.

9. A cleaning method in a cleaning apparatus for placing an article to be cleaned in a cleaning tank and removing a foreign matter on a surface of an article to be cleaned by using cleaning fluid, comprising:
in an ultrasonic generating unit of the cleaning tank, applying an ultrasonic wave to the cleaning fluid, and
in a fluid jetting unit of the cleaning tank, jetting the ultrasonic-applied cleaning fluid to an area to be cleaned which is a part to be cleaned of the article to be cleaned through an opening provided at a location corresponding to the area to be cleaned of the article to be cleaned.

10. A method for manufacturing an article, comprising:
a cleaning step of placing the article in a cleaning tank and removing a foreign matter on a surface of an article to be cleaned by using cleaning fluid,
wherein the cleaning step comprises:
in an ultrasonic generating unit of the cleaning tank, supplying a ultrasonic wave to the cleaning fluid by, and
in a fluid jetting unit of the cleaning tank, jetting the ultrasonic-applied cleaning fluid to an area to be cleaned which is a part to be cleaned of the article to be cleaned through an opening provided at a location corresponding to the area to be cleaned of the article to be cleaned.
